(19) United States
(12) Patent Application Publication
(10) Pub. No.: US 2019/0390678 A1
(43) Pub. Date: Dec. 26, 2019

(54) CENTRIFUGAL FAN

(71) Applicant: Nidec Corporation, Kyoto (JP)

(72) Inventors: Takehito TAMAOKA, Kyoto (JP); Masashi HIRAYAMA, Kyoto (JP)

(21) Appl. No.: 16/413,723

(22) Filed: May 16, 2019

(30) Foreign Application Priority Data
Jun. 22, 2018 (JP) 2018-118472

(51) Int. Cl. F04D 25/06; F04D 29/42; F04D 29/62

(52) U.S. Cl. CPC F04D 25/0613; F04D 29/4226; G06F 1/203; F05B 2240/14; F04D 29/626

(57) ABSTRACT

A centrifugal fan includes a motor, an impeller that rotates together with a rotating portion of the motor, and a housing that houses the motor and the impeller. The housing includes a cover extending perpendicularly to the center axis on the upper side of the impeller, a base extending perpendicularly to the center axis on the lower side of the impeller, a side wall connecting the cover and the base in the axial direction on the radially outer side of the impeller and defining an air blowing port together with the cover and the base in a portion of the circumferential direction, and an air inlet penetrating in the axial direction on the radially inner side of a radially outer end portion of the impeller. At least one of the base and the cover includes at least one hole penetrating in the axial direction on the radially outer side of the radially outer end portion of the impeller, and a seal that seals the hole. The specific gravity of the seal is smaller than the specific gravity of either the base or the cover, which has the hole.

### CROSS REFERENCE TO RELATED APPLICATION

The present invention claims priority under 35 U.S.C. § 119 to Japanese Application No. 2018-118472 filed on Jun. 22, 2018, the entire contents of which are incorporated herein by reference.

### FIELD OF THE INVENTION

The present invention relates to a centrifugal fan.

### BACKGROUND

Conventionally, a centrifugal fan is mounted on an electronic device such as a notebook type personal computer in order to cool the inside of a housing. The centrifugal fan has a centrifugal impeller, a motor that rotates the impeller, and a housing that houses them. When the motor of the centrifugal fan is driven, an air flow is generated inside the electronic device as the impeller rotates. As a result, heat generated from electronic parts such as a CPU mounted inside the electronic device is discharged.

The structure of a conventional centrifugal fan has a centrifugal impeller, a casing for accommodating the centrifugal impeller, and a motor including a stator. When the motor is activated, the centrifugal impeller rotates at a predetermined speed, and the air outside the casing is sucked into the casing via an upper suction port and a lower suction port provided to the casing. Then, the air sucked into the casing is accelerated in the centrifugal direction by the rotating centrifugal impeller, and then discharged from an exhaust port provided to a side surface of the casing.

In recent years, with miniaturization of electronic devices, there has been a demand for suppressing deterioration of the air blowing performance, and reducing the thickness and weight of the centrifugal fan mounted in the electronic device. In view of the above, as a method of reducing the thickness while suppressing deterioration in the blowing performance of a centrifugal fan, it is conceivable to use a method of forming a housing accommodating an impeller by applying punching or press processing to a flat metal plate, while keeping the size of the impeller constant, for example. By forming the plate of the housing by processing a metal plate, the plate can be made thin compared with the case where the plate is formed by spreading the resin in a mold, for example. Therefore, the entire housing can be made thin, finally. However, in the case of using a metal plate as described above, it is difficult to reduce the weight of the centrifugal fan having the housing, at the same time.

### SUMMARY

A centrifugal fan according to an example embodiment of the present disclosure includes a motor including a stationary portion having a stator and a rotating portion that rotates with respect to the stationary portion about a center axis extending vertically, an impeller including a plurality of blades aligned in a circumferential direction around the center axis, the impeller rotating together with the rotating portion, and a housing that accommodates at least a portion of the motor and the impeller inside the housing. The housing includes a cover extending perpendicularly to the center axis on an upper side of the impeller, a base to which the stationary portion of the motor is fixed, the base extending perpendicularly to the center axis on a lower side of the impeller, a side wall connecting the cover and the base in the axial direction on a radially outer side of the impeller, and defining an air blowing port together with the cover and the base in a portion of a circumferential direction, and an air inlet penetrating at least one of the cover and the base in the axial direction, on a radially inner side of a radially outer end portion of the impeller. At least one of the base and the cover includes at least one hole penetrating in the axial direction on a radially outer side of the radially outer end portion of the impeller, and a seal that seals the hole. A specific gravity of the seal is smaller than a specific gravity of either the base or the cover, which has the hole.

According to this example embodiment, the centrifugal fan includes at least one hole penetrating at least one of the base and the cover in the axial direction. The hole is sealed by the seal with a specific gravity that is smaller than that of either the base or the cover, which has the hole.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a longitudinal cross-sectional view of a centrifugal fan according to a first example embodiment of the present disclosure.

FIG. 2 is a partial perspective view of the centrifugal fan according to the first example embodiment of the present disclosure.

FIG. 3 is a partial longitudinal cross-sectional view of the centrifugal fan according to the first example embodiment of the present disclosure.

FIG. 4 is a longitudinal cross-sectional view of a centrifugal fan according to a modification of an example embodiment of the present disclosure.

FIG. 5 is a longitudinal cross-sectional view of a centrifugal fan according to a modification of an example embodiment of the present disclosure.

FIG. 6 is a longitudinal cross-sectional view of a centrifugal fan according to a modification of an example embodiment of the present disclosure.

FIG. 7 is a partial perspective view of a centrifugal fan according to a modification of an example embodiment of the present disclosure.

FIG. 8 is a partial perspective view of a centrifugal fan according to a modification of an example embodiment of the present disclosure.

### DETAILED DESCRIPTION

Hereinafter, example embodiments of the present invention will be described with reference to the drawings. Note that in the present application, a direction parallel to the center axis of a centrifugal fan is referred to as an “axial direction”, a direction orthogonal to the center axis is referred to as a “radial direction”, and a direction along the arc about the center axis is referred to as a “circumferential direction”. Also in the present application, the axial direction is also referred to as a vertical direction to describe the shapes or relative positions of respective parts, with the cover part side being the upper side with respect to a base part. However, the definition of the vertical direction does not intend to limit the orientation during use of the centrifugal fan of the present invention. In addition, a “parallel direction” in the present application includes a substantially parallel direction. In addition, an “orthogonal direction” in the present application includes a substantially orthogonal direction.

### 1. First Example Embodiment

### 1-1. Configuration of Centrifugal Fan

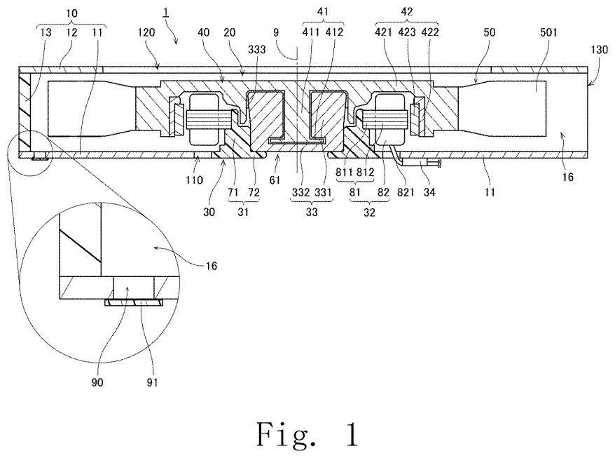

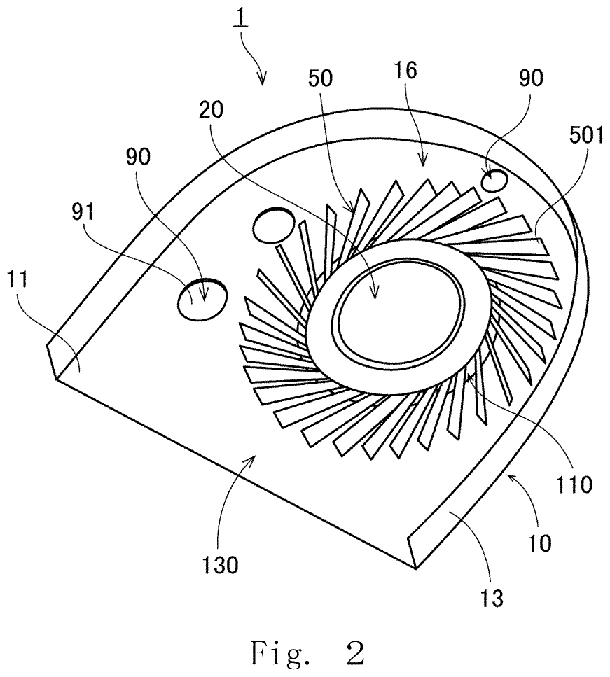

FIG. 1 is a longitudinal cross-sectional view of a centrifugal fan 1 according to a first example embodiment. FIG. 2 is a partial perspective view of a portion of the centrifugal fan 1 excluding a cover part 12. The centrifugal fan 1 is mounted in an electronic device such as a notebook type personal computer or a tablet type personal computer, and used for generating an air flow for internal cooling. However, the centrifugal fan 1 of the present invention may be used for generating an air flow for purposes other than cooling. The centrifugal fan of the present invention may also be used for devices other than electronic devices such as automobiles.

As shown in FIGS. 1 and 2, the centrifugal fan 1 has a housing 10, a motor 20, and a centrifugal impeller 50.

The housing 10 is a housing that houses at least a part of the motor 20 and the impeller 50. The housing 10 has a base part 11, a cover part 12, and a side wall part 13.

The base part 11 and the cover part 12 of the present example embodiment are formed by, for example, applying punching or press processing to a thin flat metal plate having a thickness of about 0.5 mm. By using the metal plate, the base part 11 and the cover part 12, in a thin shape, can be easily obtained. As the material of the base part 11 and the cover part 12, a metal such as stainless steel, an aluminum alloy, a galvanized steel plate, or the like is used, for example. That is, the base part 11 and the cover part 12 are made of metal. The base part 11 extends perpendicularly to the center axis 9 extending vertically, on the lower side of the impeller 50. To the base part 11, a stationary portion 30 of the motor 20, described later, is fixed. The cover part 12 expands perpendicularly to the center axis 9 on the upper side of the base part 11 and the impeller 50. That is, the cover part 12 is disposed substantially parallel to the base part 11. The upper surface of the base part 11 and the lower surface of the cover part 12 are opposed to each other.

The base part 11 of the present example embodiment has a lower air inlet 110 for taking gas into the housing 10. The lower air inlet 110 penetrates the base part 11 in the axial direction below the impeller 50 and on the radially inner side of the radially outer end portion of the impeller 50. Here, the base part 11 has a through hole 61 for fixing the stationary portion 30 of the motor 20 described later. The through hole 61 is formed coaxially with the center axis 9 and penetrates the base part 11 in the axial direction. The lower air inlet 110 is provided on the radially outer side of the peripheral portion constituting the through hole 61. In addition, the lower air inlet 110 is provided at a plurality of positions with a space in the circumferential direction around the center axis 9, as viewed in the axial direction.

The cover part 12 also has an upper air inlet 120 for taking gas into the housing 10. The upper air inlet 120 penetrates the cover part 12 in the axial direction on the upper side of the impeller 50 and on the radially inner side of the radially outer end portion of the impeller 50. The upper air inlet 120 is circular when viewed in the axial direction, and is arranged substantially coaxially with the center axis 9. As described above, in the present example embodiment, both the base part 11 and the cover part 12 are provided with air inlets for taking gas into the housing 10. However, the air inlet may be provided to at least one of the base part 11 and the cover part 12.

The side wall part 13 is formed on the base part 11 by injection molding of resin. The side wall part 13 extends upward from the base part 11 and extends along the edge portion of the base part 11 to be in contact with the lower surface of the cover part 12. Further, the cover part 12 is fixed to the side wall part 13 by screwing or bonding. As a result, the base part 11 and the cover part 12 are connected to each other in the axial direction by the side wall part 13 on the radially outer side of the impeller 50. Further, the side wall part 13 forms an air blowing port 130 together with the base part 11 and the cover part 12 in a part of the circumferential direction. The base part 11, the cover part 12, and the side wall part 13 constitute a wind tunnel region 16 surrounding the impeller 50. The wind tunnel region 16 is located on the upper side of the base part 11, the lower side of the cover part 12, the radially inner side of the side wall part 13, and the radially outer side of the impeller 50. Further, the wind tunnel region 16 communicates with the space outside the housing 10 in the radial direction via the air blowing port 130.

The motor 20 generates a torque according to a drive current and rotates the impeller 50. The motor 20 has a stationary portion 30 and a rotating portion 40. The stationary portion 30 is relatively stationary with respect to the housing 10. The rotating portion 40 is supported so as to be rotatable around the center axis 9 with respect to the stationary portion 30.

The stationary portion 30 of the present example embodiment has a holder 31, a stator 32, a stationary bearing 33, and a circuit board 34.

The holder 31 is formed on the radially inner side of the base part 11 by injection molding of resin. The holder 31 has a cylindrical portion 71 and a bottom plate portion 72. The bottom plate portion 72 extends annularly in the through hole 61. The cylindrical portion 71 extends upward in a cylindrical shape from the bottom plate portion 72. The cylindrical portion 71 and the bottom plate portion 72 annularly surround the center axis 9.

The stator 32 includes a stator core 81 and coils 82. The stator 32 is positioned above the base part 11 and outside in the radial direction of the cylindrical portion 71. The stator core 81 is formed of, for example, a laminated steel plate in which electromagnetic steel plates such as silicon steel plates are laminated in the axial direction. The stator core 81 is indirectly supported on the base part 11 via the holder 31 by being fixed to the outer peripheral surface of the cylindrical portion 71 with, for example, an adhesive. The stator core 81 may be directly supported by the base part 11.

The stator core 81 includes an annular core back 811 and a plurality of teeth 812 arranged to project radially outward from the core back 811. The plurality of coils 82 is an aggregate of conductive wires 821 wound around the plurality of teeth 812. A part of the conductive wire 821 passes through the lower air inlet 110 and is drawn downward from the base part 11, for example. The teeth 812 and the coils 82 are preferably arranged at substantially equal intervals in an annular shape in the circumferential direction around the center axis 9.

The stationary bearing 33 is supported by being fixed to the inside of the holder 31 by adhesion. The stationary bearing 33 has a sleeve portion 331 and a thrust portion 332. The sleeve portion 331 extends in a substantially cylindrical shape around the center axis 9. The thrust portion 332 extends like a plate in the radial direction around the center axis 9, and closes a lower end portion of the sleeve portion 331. A part of a shaft part 41 of a rotating portion 40, which will be described later, is accommodated in the radially inner side of the sleeve portion 331 and on the upper side of the thrust portion 332.

On the lower surface of the base part 11, a circuit board 34 for supplying a drive current to the motor 20 is disposed. The circuit board 34 is connected with the above-described conductive wire 821. As a result, the circuit board 34 is electrically connected to the stator 32. The drive current of the motor 20 is supplied from the external power supply (not shown) to the coils 82 via the circuit board 34 and the conductive wire 821.

The rotating portion 40 of the present example embodiment has the shaft part 41 and a rotor part 42.

The shaft part 41 is disposed along the center axis 9. The shaft part 41 has a shaft body portion 411 and a shaft flange portion 412. The shaft body portion 411 extends in a columnar shape along the center axis 9. The shaft flange portion 412 expands radially outward from the lower end portion of the shaft body portion 411.

The outer peripheral surface of the shaft body portion 411 and the inner peripheral surface of the sleeve portion 331 face each other in the radial direction via a slight gap with lubricating liquid 333 interposed therebetween. At least one of the outer peripheral surface of the shaft body portion 411 and the inner peripheral surface of the sleeve portion 331 has a plurality of dynamic pressure grooves (not shown). The lower surface of the shaft flange portion 412 and the upper surface of the thrust portion 332 face each other in the axial direction via a slight gap with the lubricating liquid 333 interposed therebetween. At least one of the lower surface of the shaft flange portion 412 and the upper surface of the thrust portion 332 has a plurality of dynamic pressure grooves (not shown). Further, the upper surface of the shaft flange portion 412 and the lower surface of the sleeve portion 331 face each other in the axial direction via a slight gap with the lubricating liquid 333 interposed therebetween. In the present example embodiment, the lubricating liquid 333 continuously exists between the inside of the stationary bearing 33 and the outside of the shaft part 41. As the lubricating liquid 333, a polyolester based oil or a diester based oil is used, for example.

When the motor 20 is driven, hydrodynamic pressure is induced in the lubricating liquid 333 by the dynamic pressure grooves. As a result, the rotating portion 40 is supported by the stationary portion 30, whereby it rotates stably. That is, in the present example embodiment, a fluid dynamic pressure bearing is formed of the stationary bearing 33 that is a member on the stationary portion 30 side, the shaft part 41 that is a member on the rotating portion 40 side, the dynamic pressure grooves, and the lubricating liquid 333. The rotating portion 40 is rotatably supported by the fluid dynamic pressure bearing. However, instead of the fluid dynamic pressure bearing, other types of bearings such as a sliding bearing may be used.

The rotor part 42 includes a rotor holder 421, a yoke 422, and a magnet 423.

The rotor holder 421 expands radially outward from the upper portion of the shaft part 41 and extends substantially in a cylindrical shape toward the lower side in the axial direction on the radially outer side of the stator 32.

The yoke 422 is an annular member arranged substantially coaxially with the center axis 9. The yoke 422 is fixed to the inner peripheral surface of the rotor holder 421 by, for example, an adhesive or caulking on the radially outer side of the stator 32. As a material of the yoke 422, a ferromagnetic material such as iron is used. Thereby, it is possible to suppress leakage of the magnetic flux generated from the magnet 423 to the outside.

The magnet 423 is fixed to the inner peripheral surface of the yoke 422 with an adhesive, for example. An annular permanent magnet is used as the magnet 423 of the present example embodiment. The magnet 423 is located on the radially outer side of the stator 32. The inner peripheral surface of the magnet 423 faces the radially outer end surfaces of the teeth 812 of the stator 32 in the radial direction via a slight gap. In addition, on the inner peripheral surface of the magnet 423, the N pole and S pole are arranged alternately in the circumferential direction. Note that a plurality of magnets may be used in place of the annular magnet 423. In that case, the magnets may be arranged on the inner peripheral surface of the yoke 422 in such a manner that the pole face of the N pole and the pole face of the S pole are arranged alternately in the circumferential direction.

The impeller 50 has a plurality of blades 501. The blades 501 are disposed on the upper side of the base part 11 and on the lower side of the cover part 12. Each of the blades 501 extends radially outward from the outer peripheral surface of the rotor holder 421. Further, as shown in FIG. 2, the blades 501 are arranged at equal intervals in the circumferential direction around the center axis 9.

In the present example embodiment, the shaft part 41, the rotor part 42, and the impeller 50 form an integral part. However, the shaft part 41, the rotor part 42, and the impeller 50 may be separate parts, respectively. For example, the rotor part and the shaft part may be separate parts, and an upper portion of the shaft part may be fixed to a through hole provided at the center of the rotor part by adhesion or press fitting. In addition, each of the shaft part 41, the rotor part 42, and the impeller 50 may be configured of a plurality of members.

When a driving current is supplied to the coils 82 of the stator 32, magnetic flux is generated in the teeth 812 of the stator core 81. In addition, a torque in the circumferential direction is generated by the action of the magnetic flux between the teeth 812 and the magnet 423. As a result, the rotating portion 40 of the motor 20 rotates about the center axis 9. Further, the impeller 50, which is an integral part of the rotating portion 40, rotates about the center axis 9 together with the rotating portion 40. When the impeller 50 rotates, gas is taken from the space above the housing 10 through the upper air inlet 120 and from the space below the housing 10 through the lower air inlet 110 into the interior of the housing 10. The gas taken into the housing 10 receives a centrifugal force by the impeller 50, and is discharged from the wind tunnel region 16 in the housing 10 to a side of the housing 10 via the air blowing port 130. Thereby, it is possible to cool the electronic device on which the centrifugal fan 1 is mounted.

### 1-2. Detailed Configuration of Base Part

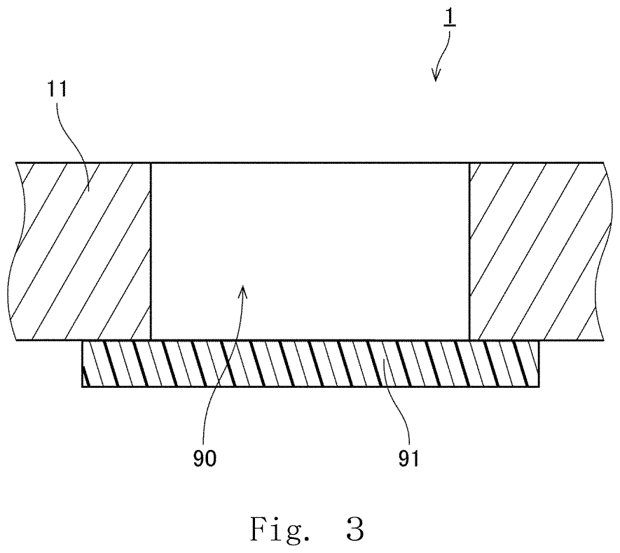

Next, a more detailed configuration of the base part 11 will be described. FIG. 3 is a partial longitudinal cross-sectional view of the centrifugal fan 1 according to the first example embodiment. In the below description, description will be given with reference to FIG. 3, and FIGS. 1 and 2 as appropriate.

As shown in FIGS. 1 to 3, the base part 11 has a hole 90. The hole 90 penetrates the base part 11 in the axial direction on the radially outer side of the radially outer end portion of the impeller 50. Further, the hole 90 has a circular shape when viewed in the axial direction. As compared with the case where the hole 90 has a polygonal shape having a plurality of corners, the hole 90 can be formed easily. At the time of manufacturing the centrifugal fan 1, the hole 90 is provided by, for example, punching a flat metal plate forming the base part 11. In the present example embodiment, three holes 90 are provided in the base part 11. However, at least one hole 90 may be provided to the base part 11. The number of the holes 90 is not limited to three. That is, the number of the holes 90 provided to the base part 11 may be one, or may be plural. In the present example embodiment, not a single large hole but a plurality of holes 90 are provided with an interval between them. Therefore, the strength of the base part 11 is secured at a certain level or more.

The base part 11 has a seal part 91. More specifically, on the lower surface of the base part 11, seal parts 91 for sealing the three holes 90 are disposed respectively. For example, a sheet made of thin paper or resin having a thickness of about 0.1 mm in which one side is coated with an adhesive or gluing agent, is used as the seal part 91. At the time of manufacturing the centrifugal fan 1, the seal part 91 is attached to the lower surface of the base part 11 to seal the hole 90. With use of the sheet-like seal part 91 made of resin, the base part 11 can be easily sealed. In the present example embodiment, each hole 90 is sealed by a seal part 91 having an area slightly larger than each hole 90 when viewed in the axial direction. Thereby, since the amount of use of the seal part 91 can be suppressed, it leads to cost reduction. Note that the seal part 91 may be disposed over the entire surface of the lower surface of the base part 11 by one seal part. This makes it possible to reduce the number of steps as compared with the case where a plurality of seal parts 91 are attached to the lower surface of the base part 11.

The specific gravity of the seal part 91 is smaller than the specific gravity of the base part 11. The material weight of the seal part 91 is lighter than the material weight of the base part 11 originally present in the space formed by the hole 90 of the base part 11. In this manner, by providing the hole 90 to the base part 11 having a large material weight and sealing the hole 90 with the seal part 91 having a small material weight instead, it is possible to reduce the weight of the centrifugal fan 1 including the base part 11. At the same time, it is possible to restrain gas from entering and exiting the wind tunnel region 16 in the housing 10 through the hole 90. As a result, it is possible to suppress deterioration of the blowing performance and realize the weight reduction of the centrifugal fan 1.

### 2. Modification

While the exemplary example embodiments of the present invention have been described above, the present invention is not limited to the example embodiments described above.

In the example embodiment described above, the hole 90 penetrates the base part 11 in the axial direction, and the seal part 91 is disposed on the lower surface of the base part 11. However, the hole 90 may penetrate the cover part 12 in the axial direction on the radially outer side of the radially outer end portion of the impeller 50. In detail, the cover part 12 may have the hole 90. Further, the seal part 91 having a specific gravity smaller than the specific gravity of the cover part 12 may be arranged so as to seal the hole 90 on the upper surface of the cover part 12. Specifically, the cover part 12 may have the seal part 91. Accordingly, it is also possible to suppress deterioration of the blowing performance and to reduce the weight of the centrifugal fan 1.

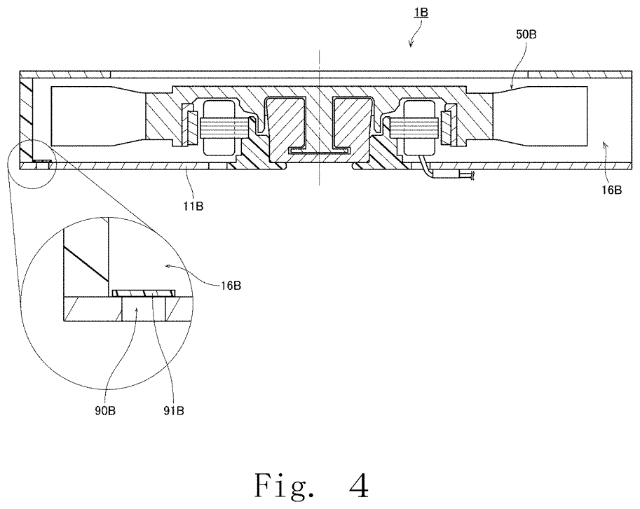

FIG. 4 is a longitudinal cross-sectional view of a centrifugal fan 1B according to a modification. In the example of FIG. 4, a hole 90B penetrates a base part 11B in the axial direction on the radially outer side of the radially outer end portion of an impeller 50B. A seal part 91B having a smaller specific gravity than the specific gravity of the base part 11B is disposed so as to seal the hole 90B on the upper surface of the base part 11B. As a result, as in the above-described example embodiment, it is possible to suppress deterioration of the blowing performance and to reduce the weight of the centrifugal fan 1B. The thickness of the seal part 91B is sufficiently smaller than the thickness of the base part 11B. In this modification, by disposing the seal part 91B on the upper surface of the base part 11B facing the wind tunnel region 16B, the upper surface in the vicinity of the hole 90B of the base part 11B can be brought into a state with substantially no step. Therefore, it is possible to suppress the influence of the wind tunnel region 16B on the air flow.

Further, the hole may penetrate the cover part in the axial direction on the radially outer side of the radially outer end portion of the impeller, and the seal part may be disposed on the lower surface of the cover part. Thereby, since the lower surface in the vicinity of the hole of the cover part can be brought into a state with substantially no step, the influence of the wind tunnel region on the air flow can be suppressed.

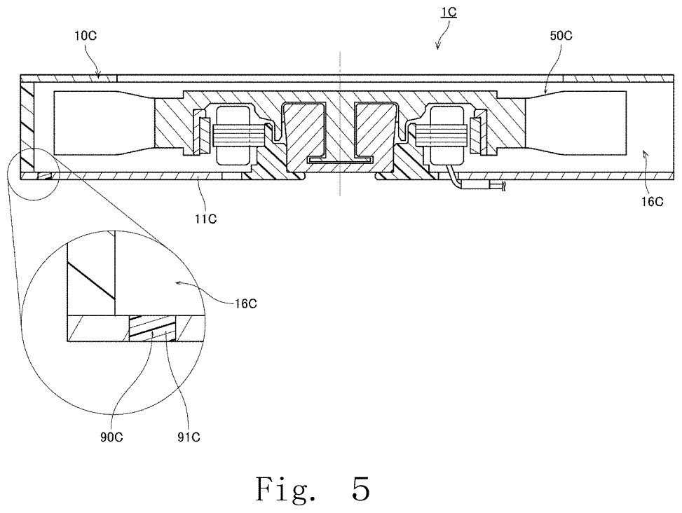

FIG. 5 is a longitudinal cross-sectional view of a centrifugal fan 1C according to another modification. In the example of FIG. 5, a hole 90C penetrates the base part 11C in the axial direction on the radially outer side of the radially outer end portion of an impeller 50C. On the other hand, unlike the example embodiment and the modification described above, in the example of FIG. 5, a seal part 91C having a specific gravity smaller than the specific gravity of the base part 11C is disposed inside the hole 90C. As the seal part 91C, a thermosetting resin is used. At the time of manufacturing the centrifugal fan 1C, the seal part 91C in a liquid form is placed in the hole 90C and then the liquid seal part 91C is cured to seal the hole 90C. Thereby, it is possible to reduce the weight of the centrifugal fan 1C including the base part 11C. At the same time, it is possible to suppress the entry and exit of gas into the wind tunnel region 16C in a housing 10C via the hole 90C. As a result, it is possible to suppress deterioration of the blowing performance and realize weight reduction of the centrifugal fan 1C. Further, the upper surface in the vicinity of the hole 90C of the base part 11C can be brought into a state with substantially no step. Therefore, the influence of the wind tunnel region 16C on the air flow can be suppressed.

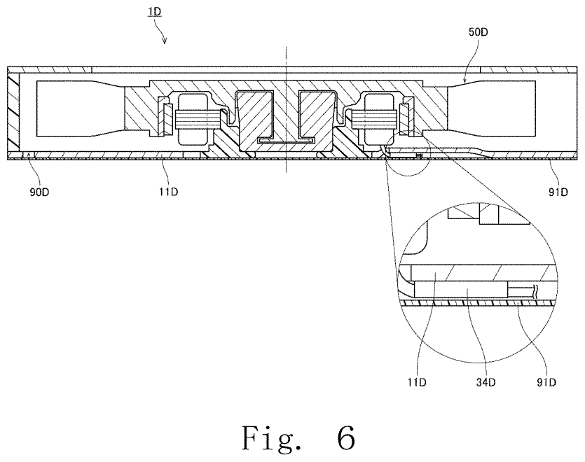

FIG. 6 is a longitudinal cross-sectional view of a centrifugal fan 1D according to another modification. In the example of FIG. 6, a hole 90D penetrates a base part 11D in the axial direction on the radially outer side of the radially outer end portion of an impeller 50D. On the other hand, a seal part 91D is mounted over the entire lower surface of the base part 11D, and seals the hole 90D from below. At least a part of a circuit board 34D disposed on the lower surface of the base part 11D is disposed between the base part 11D and the seal part 91D in the axial direction. This further suppresses the circuit board 34D from falling off the base part 11D.

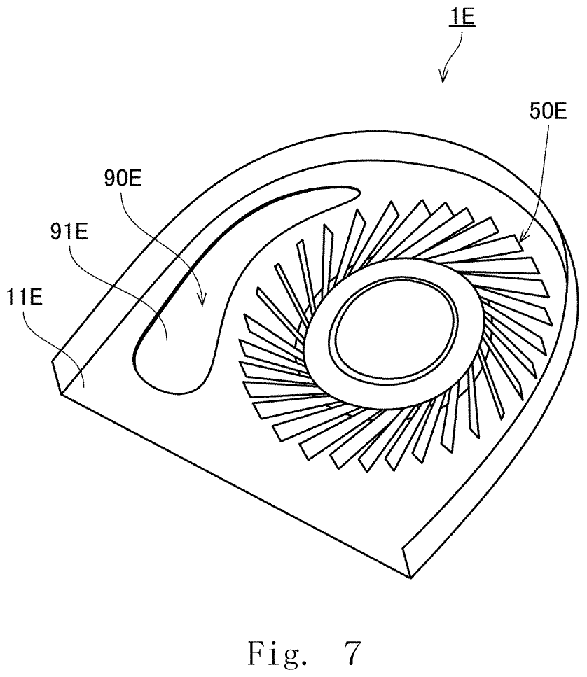

FIG. 7 is a partial perspective view of a part of a centrifugal fan 1E according to another modification excluding the cover part. In the example of FIG. 7, a base part 11E is provided with one hole 90E on the radially outer side of the radially outer end portion of an impeller 50E. The hole 90E penetrates the base part 11E in the axial direction and has an area larger than the total area of the plurality of holes described in the example embodiment and the modifications described above, when viewed in the axial direction. The hole 90E is sealed by a seal part 91E. In this way, in the case of providing one hole 90E, it is possible to reduce the work amount of punching performed on the base part 11E, and to further reduce the volume of the base part 11E to thereby reduce the weight of the centrifugal fan 1E.

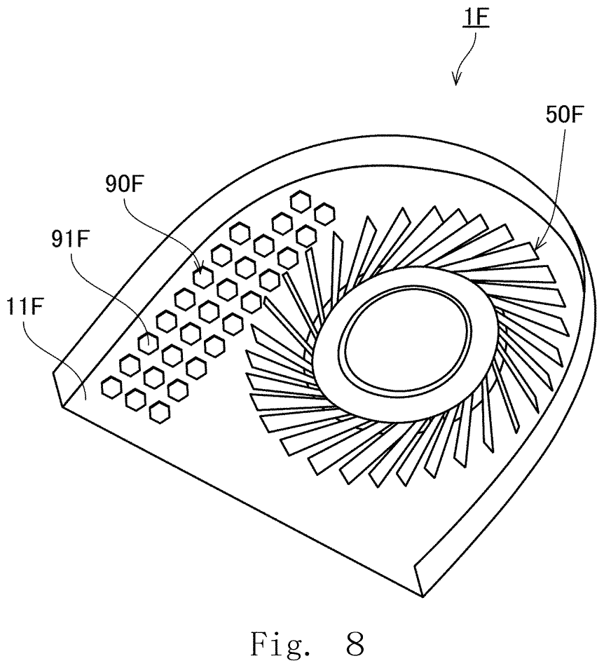

FIG. 8 is a partial perspective view of a part of a centrifugal fan 1F according to another modification, excluding the cover part. In the example of FIG. 8, a plurality of holes 90F are arranged in a grid pattern on a base part 11F, when viewed in the axial direction, on the radially outer side of the radially outer end portion of an impeller 50F. In addition, in the present modification, each of the holes 90F penetrates the base part 11F in the axial direction, and has a hexagonal shape when viewed in the axial direction. However, the shape of each hole 90F is not limited thereto. By providing a plurality of holes 90F in a lattice shape with a space therebetween as in the present modification, it is possible to reduce the weight of the centrifugal fan 1F while ensuring the strength of the base part 11F at a certain level or more.

That is, in the centrifugal fan of the present invention, a hole that penetrates at least one of the base part and the cover part in the axial direction is provided on the radially outer side of the radially outer end portion of the impeller. A seal part having a smaller specific gravity than the specific gravity of either the base part or the cover part, having the hole, is arranged so as to seal the hole. As a result, it is possible to suppress deterioration of the blowing performance and to reduce the weight of the centrifugal fan. Note that the number of holes provided in at least one of the base part and the cover part may be one or plural. The seal part may be disposed on a surface facing the impeller in the axial direction in either the base part or the cover part that has the hole, or may be disposed on a surface opposite to the surface facing the impeller in the axial direction. Furthermore, the seal part may be disposed inside the hole.

Furthermore, the detailed shapes of the centrifugal fan may be different from the shapes shown in the respective drawings of this specification.

In addition, the elements that appear in the above-described example embodiment and modifications may also be appropriately combined in a range in which there is no contradiction.

The present invention is applicable to a centrifugal fan.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A centrifugal fan comprising:
a motor including a stationary portion including a stator, and a rotating portion that rotates with respect to the stationary portion about a center axis extending vertically;
an impeller including a plurality of blades aligned in a circumferential direction around the center axis, the impeller rotating together with the rotating portion; and
a housing that accommodates at least a portion of the motor and the impeller inside the housing; wherein
the housing includes:
a cover extending perpendicularly to the center axis on an upper side of the impeller;
a base to which the stationary portion of the motor is fixed, the base extending perpendicularly to the center axis on a lower side of the impeller;
a side wall connecting the cover and the base in an axial direction on an radially outer side of the impeller, the side wall defining an air blowing port together with the cover and the base in a portion of a circumferential direction; and
an air inlet penetrating at least one of the cover and the base in the axial direction, on a radially inner side of a radially outer end portion of the impeller;
at least one of the base and the cover includes:
at least one hole penetrating in the axial direction on a radially outer side of the radially outer end portion of the impeller; and
a seal that seals the at least one hole, and
a specific gravity of the seal is smaller than a specific gravity of either the base or the cover, which has the at least one hole.

2. The centrifugal fan according to claim 1, wherein
the at least one hole penetrates the base in the axial direction; and
the seal is disposed on a lower surface of the base.

3. The centrifugal fan according to claim 2, wherein
the stationary portion further includes a circuit board electrically connected to the stator; and
at least a portion of the circuit board is disposed between the base and the seal.

4. The centrifugal fan according to claim 1, wherein
the at least one hole penetrates the cover in the axial direction; and
the seal is disposed on an upper surface of the cover.

5. The centrifugal fan according to claim 1, wherein the seal is disposed on a surface, facing the impeller in the axial direction, of either the base or the cover, which has the at least one hole.

6. The centrifugal fan according to claim 1, wherein the seal is disposed in the at least one hole.

7. The centrifugal fan according to claim 1, wherein a number of the at least one hole provided to the base or the cover is one.

8. The centrifugal fan according to claim 1, wherein a number of the at least one hole provided to the base or the cover is plural.

9. The centrifugal fan according to claim 1, wherein a shape of the at least one hole is circular when viewed in the axial direction.

10. The centrifugal fan according to claim 8, wherein a plurality of the holes are arranged in a lattice shape when viewed in the axial direction.

11. The centrifugal fan according to claim 1, wherein the base and the cover are made of metal.

12. The centrifugal fan according to claim 1, wherein the seal is made of resin.

13. The centrifugal fan according to claim 6, wherein a material of the seal is a thermosetting resin.
